(19) United States
(12) Patent Application Publication
(10) Pub. No.: US 2021/0222929 A1
(43) Pub. Date: Jul. 22, 2021

(54) COMPRESSOR SYSTEM WITH MULTIPLE COMPRESSOR ELEMENTS

(71) Applicant: Carrier Corporation, Palm Beach Gardens, FL (US)

(72) Inventors: Nicolas Fonte, Montluel (FR); Hugo Herry, Montluel (FR)

(21) Appl. No.: 17/123,738

(22) Filed: Dec. 16, 2020

(30) Foreign Application Priority Data
Jan. 22, 2020 (EP) 20153195.1

(51) Int. Cl. F25B 49/02; F25B 13/00

(52) U.S. Cl. CPC F25B 49/022; F25B 13/00; F04C 18/0207; F25B 2700/1933; F25B 2500/18; F25B 2700/1931

(57) ABSTRACT

Compressor systems for compression of refrigerant fluid are described. The compressor systems include first and second compressor elements each having a housing. An equalization line fluidly connects the first and second housings at suction sides in order to allow for equalization of pressure between the housings as well as flow of lubricant between the housings. An equalization valve on the equalization line is used to open and close the connection between the first and second compressor element housings. The compressor system is arranged for full load operation using both the first and second compressor elements as well as for part load operation in which one of the compressor elements is not utilized. The equalization valve is opened during full load operation and is closed during part load operation to thereby prevent movement of lubricant and/or refrigerant fluid between the first and second compressor element housings during part load operation.

### CROSS-REFERENCE TO RELATED APPLICATIONS

This application claims priority to European Patent Application No. 20153195.1, filed Jan. 22, 2020, the contents of which are incorporated by reference herein in their entirety.

### BACKGROUND

The present invention relates to a compressor system using multiple compressor elements for compression of refrigerant fluid, as well as to a corresponding method for operating such a compressor system.

It is required to compress refrigerant fluid in various types of refrigeration circuit using a refrigeration cycle. This includes refrigeration cycles used for providing cooling, such as in refrigerated storage and/or air conditioning systems, as well as refrigeration cycles used for providing heating, such as in the case of heat pumps. A typical compressor requires lubrication, which can come from the refrigerant fluid more often involves an added lubricant. It is important to handle the lubricant effectively. Some known compressors use multiple compressor elements, in particular multiple parallel compressor elements allowing for variation in load by activating or de-activating one or more compressor elements to adjust the compression capacity. This type of arrangement is known for compressor elements such as scroll compressors or rotary compressors.

### SUMMARY

According to some embodiments, compressor systems for compression of refrigerant fluid are provided. The compressor systems include a first compressor element for compression of the refrigerant fluid, the first compressor element being within a first compressor element housing, a second compressor element for compression of the refrigerant fluid, the second compressor element being within a second compressor element housing, an equalization line that fluidly connects the first and second compressor element housings at the suction side in order to allow for equalization of pressure between the first and second compressor element housings as well as flow of lubricant between the compressor element housings, and an equalization valve on the equalization line for opening and closing the connection between the first and second compressor element housings via the equalization line. The compressor system is arranged for full load operation using both the first and second compressor elements as well as for part load operation in which one of the compressor elements is not utilized. The compressor system is arranged to open the equalization valve during full load operation. The compressor system is arranged to close the equalization valve during part load operation to thereby prevent movement of lubricant and/or refrigerant fluid between the first and second compressor element housings during part load operation.

In addition to one or more of the features described herein, or as an alternative, further embodiments of the compressor systems may include that the compressor system is configured for passive distribution of lubricant driven by pressure differentials generated by the compressor elements in order to move lubricant between the compressor element housings.

In addition to one or more of the features described herein, or as an alternative, further embodiments of the compressor systems may include that the compressor system does not comprise a lubricant pump.

In addition to one or more of the features described herein, or as an alternative, further embodiments of the compressor systems may include that each compressor element housing includes a lubricant sump at the suction side and the equalization line provides a connection between the lubricant sumps of the first and second compressor element housings.

In addition to one or more of the features described herein, or as an alternative, further embodiments of the compressor systems may include that the equalization line connects to each compressor element housing at an equivalent location in order that the expected pressure at the opening of the equalization line is the same during balanced operation of the compressor elements.

In addition to one or more of the features described herein, or as an alternative, further embodiments of the compressor systems may include that the compressor elements provide differing capacities and/or at least one compressor element provides a varying capacity.

In addition to one or more of the features described herein, or as an alternative, further embodiments of the compressor systems may include that the equalization valve is arranged to be closed in reaction to pressure conditions that arise when the second compressor element is inactive.

In addition to one or more of the features described herein, or as an alternative, further embodiments of the compressor systems may include that he systems are scroll compressor systems wherein the compressor elements are scroll compressor elements.

In addition to one or more of the features described herein, or as an alternative, further embodiments of the compressor systems may include that the systems are rotary compressor systems wherein the compressor elements are rotary compressor elements.

In addition to one or more of the features described herein, or as an alternative, further embodiments of the compressor systems may include at least one further compressor element.

In addition to one or more of the features described herein, or as an alternative, further embodiments of the compressor systems may include at least one further equalization line with a corresponding further equalization valve.

In addition to one or more of the features described herein, or as an alternative, further embodiments of the compressor systems may include that the at least two equalization lines connect the at least three compressor element housings in series.

In addition to one or more of the features described herein, or as an alternative, further embodiments of the compressor systems may include a controller for controlling the compressor system to operate in the part load mode or full load mode.

According to some embodiments, refrigeration circuits are provided. The refrigeration circuits include the compressor systems as described in any preceding embodiment.

According to some embodiments, methods for operating a compressor system or refrigeration circuit as in any above described embodiment are provided. The methods include selecting between full load operation with all compressor elements being used, and part load operation with one of the compressor elements being inactive, opening the equalization valve during full load operation, and closing the equalization valve during part load operation to thereby prevent movement of lubricant and/or refrigerant fluid between the first and second compressor element housings during part load operation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 shows a refrigeration circuit including a compressor; and

FIGS. 2a and 2b are schematic diagrams of a compressor system having two compressor elements.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Viewed from a first aspect, the invention provides a compressor system for compression of refrigerant fluid, the compressor system comprising: a first compressor element for compression of the refrigerant fluid, the first compressor element being within a first compressor element housing; a second compressor element for compression of the refrigerant fluid, the second compressor element being within a second compressor element housing; an equalization line that fluidly connects the first and second compressor element housings at the suction side in order to allow for equalization of pressure between the first and second compressor element housings as well as flow of lubricant between the compressor element housings; and an equalization valve on the equalization line for opening and closing the connection between the first and second compressor element housings via the equalization line; wherein the compressor system is arranged for full load operation using both the first and second compressor elements as well as for part load operation in which one of the compressor elements is not utilized; wherein the compressor system is arranged to open the equalization valve during full load operation; and wherein the compressor system is arranged to close the equalization valve during part load operation to thereby prevent movement of lubricant and/or refrigerant fluid between the first and second compressor element housings during part load operation.

With this arrangement the equalization line allows for movement of fluid between the suction sides of the first and second compressor element housings, thereby enabling equalization of pressure via movement of lubricant and/or refrigerant fluid. The equalization line is always closed during part load operation when one of the first and second compressor elements is not utilized. This is significant since otherwise the suction in the operational compressor element housing would draw lubricant across from the inactive compressor element housing, leading to imbalances in operation and inefficiencies due to excessive lubrication of the compressor element. As well as that, there would be a risk of excess lubricant being circulated in a refrigeration circuit with the compressed refrigerant from the compressor system. Closure of the equalization valve also means that refrigerant fluid cannot flow along the equalization line during part load operation, i.e. that recirculation of gas/gas bypass is prevented.

Thus, the equalization line, combined with the equalization valve and closure thereof during part load operation, have the result that lubricant can be more effectively distributed during full load operation whilst ensuring that unwanted redistribution of lubricant is avoided during part load operation. The compressor system can always operate with optimized distribution of lubricant, which increases the volumetric compression efficiency.

It is important to note that the proposed arrangement differs from multiple compressor element compressor systems using equalization lines at the discharge side rather than the suction side of the compressor element housings. Such systems tend to have different forms and differing requirements for distribution of lubricant. As well as differing from the use of equalization lines at the discharge side, the proposed arrangement also differs considerably from compressor systems requiring more complex arrangements for separation and distribution of lubricant. In particular, in example embodiments the present compressor system does not comprise a separator for separation of lubricant from refrigerant. The compressor system may rely on gravity and/or acceleration forces from movement of the compressor elements for separation of lubricant. Alternatively, or additionally, the compressor system does not comprise a means for active distribution of lubricant. Instead the compressor system advantageously relies on passive distribution of lubricant driven by pressure differentials generated by the compressor elements in order to move lubricant between the compressor element housings. Thus, the compressor system does not comprise a lubricant pump, for example.

Each compressor element housing may include a lubricant sump, typically at the base of the housing, i.e. the lower most part thereof when the compressor is in use. The equalization line may provide a connection between the lubricant sumps of the first and second compressor element housings, and the sumps may be located at the suction sides of the housings. In that case there is predominantly movement of lubricant during equalization of pressures when the first and second compressor elements are active with the equalization valve open, as opposed to movement of refrigerant. The suction pressure can equalize effectively and there is correct distribution of lubricant. When both of the compressor elements are being used then if there is a differential in the suction pressures then the lower pressure compressor element housing will draw lubricant across from the higher pressure compressor element housing and the suction pressures will become balanced due to the lubricant movement. Conversely, the amount of lubricant within the compressor element housing impacts on the compression efficiency and on the internal pressures so that excessive lubricant levels in one of the compressor element housings will cause an imbalance in internal pressures, with this being balanced out automatically by movement of lubricant through the equalization line when the equalization valve is open.

The equalization line is connected at the suction side of each compressor element housing. The compressor element housings each have a suction side and a discharge side. The suction side is the lower pressure side, coupled to a suction inlet port of the compressor system, and the discharge side is the higher pressure side, coupled to an outlet port of the compressor system. When the compressor element is in use refrigerant fluid enters at the suction side, is compressed by action of the compressor element, e.g. by rotational movement thereof, and moves to the discharge side, before it is expelled from the outlet port with increased pressure compared to the pressure at the inlet port.

The equalization line may connect to each compressor element housing at an equivalent location in order that the expected pressure at the opening of the equalization line is the same during balanced operation of the compressor elements. Thus, the equalization line may connect to each compressor element housings at a similar point in terms of expected internal pressure when the compressor element is active. This allows for effective balancing of pressure without any form of active control being needed, i.e. simply with the equalization valve open during full load operation as discussed above.

The first and/or second compressor element may be a scroll compressor element or a rotary compressor element and hence the compressor system may be a scroll compressor system or a rotary compressor system. Typically, the first and second compressor elements are of the same type. The proposed suction side equalization control may be applied to any compressor system having multiple compressor elements and using an equalization line at the suction side. Advantageously this is done for systems without lubricant separation as discussed above. Thus, for example, the compressor elements would not be screw compressor elements or piston compressor elements where there is generally a requirement for further separation of lubricant and where it is not straightforward to apply equalization at the suction sides.

The compressor system includes first and second compressor elements and may optionally include further compressor elements, such as a third compressor element with a corresponding compressor element housing of similar configuration to the first and second compressor element housings. In that case the compressor system may be configured for a full load mode of operation where all three compressor elements are used, as well as multiple part load modes of operation where either one or two of the compressor elements are not utilized. Where more than two compressor elements are present then the compressor system may also comprise at least one further equalization line with a corresponding further equalization valve. Thus, for example, with three compressor elements there may be two equalization lines. The equalization lines may connect the suction sides of the compressor element housings in pairs using a sequence corresponding to the sequence in which the compressor elements are deactivated during the part load modes of operation. Thus, the equalization lines may connect the compressor element housings in series. The compressor system may be arranged to operate with selected equalization valves closed during part load operation in order to prevent flow of fluids along the equalization lines to or from the compressor element housing(s) of the compressor elements that are inactive during the part load operation in question.

The compressor elements may be arranged for parallel compression, i.e. in a tandem arrangement, such that adding/using further compressor elements may increase the compression capacity. The first and second compressor elements, and optional further compressor elements, may provide similar compression capacities, in which case the capacity at full load may be approximately double the capacity at part load for a two compressor element system. Alternatively, the compressor elements may provide differing capacities and/or at least one compressor element may provide a varying capacity, such as through being a variable speed compressor element. The proposed equalization line can usefully enhance operation of multiple compressor element compressor systems where there are differing and/or variable capacities.

The compressor system may include a controller, such as a microprocessor controller. The controller may be arranged to control the compressor system to operate in the part load mode or full load mode. The mode may be selected according to external inputs to the controller. The controller may be a controller of a refrigeration circuit that uses the compressor system. The controller optionally also controls operation of the equalization valve, and thus may automatically close the equalization valve when the part load mode of operation is selected, as well as controlling the compressor elements accordingly.

Advantageously, the equalization valve is of simple construction having an open state and a close state, without the need for a controllable variable degree of opening. The equalization valve may be a shut off valve, for example. The equalization valve may be controlled via electronic actuation, such as by using a controller as discussed above. Alternatively, the equalization valve may be operated mechanically with closure of the equalization valve triggered by operating conditions of the compressor system, such as an absence of pressure in the discharge side of the second compressor element and/or a differential pressure between the two compressor elements that is beyond a set threshold. Thus, the equalization valve may be arranged to be closed in reaction to pressure conditions that arise when the second compressor element is inactive.

The lubricant is typically oil and may be an oil selected based on the compressor element requirements as well as on the refrigerant type. When in use the compressor system may include the lubricant within the sumps of the compressor element housings with the lubricant level being vertically above the connections to the equalization line during balanced operating conditions, i.e. with equal lubricant levels during full load operation.

The compressor system may be configured to operate with a refrigerant fluid of a suitable type for the compressor elements and may include said refrigerant fluid in the compressor element housings when the compressor system is in use. In one example the refrigerant is a high pressure refrigerant such as R32. This has been found to give significant performance increases, in particular when paired with scroll compressor elements.

The invention further extends to a refrigeration circuit comprising the compressor system. This may be a circuit using a refrigeration cycle for providing heating or cooling, for example. The refrigeration circuit may comprise a heat rejecting heat exchanger, an expansion device, and a heat absorbing heat exchanger.

Viewed from another aspect, the invention provides a method for operating a compressor system as described above, the method including: selecting between full load operation with all compressor elements being used, and part load operation with one of the compressor elements being inactive; opening the equalization valve during full load operation; and closing the equalization valve during part load operation to thereby prevent movement of lubricant and/or refrigerant fluid between the first and second compressor element housings during part load operation.

The method may include using a compressor system with any of the other features discussed above and thus may comprise handling of the lubricant absent a lubricant separator and/or with passive flow of lubricant within the system, which may be absent a lubricant pump or the like. The method may include operating the compressor system within a refrigeration circuit and hence may comprise compressing refrigerant with the compressor system and circulating the refrigerant through a refrigeration cycle in order to provide heating and/or cooling.

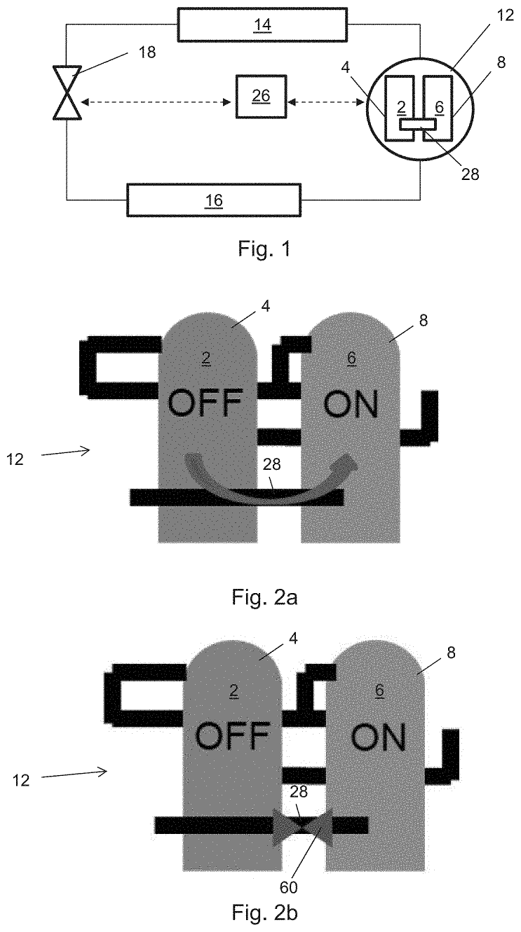

As seen in FIG. 1, a refrigeration circuit includes a compressor system 12, a heat rejecting heat exchanger 14, an expansion device 18 and a heat absorbing heat exchanger 16 that operate together in a refrigeration/heat pump cycle. The heat pump system contains a refrigerant fluid and circulation of the refrigerant fluid via the compressor system 12 enables the refrigeration system to utilize a refrigeration cycle to satisfy a heating load. In this example the heat rejecting heat exchanger 14 is a condenser for at least partially condensing the refrigerant fluid, the expansion device 18 is an expansion valve for expanding the refrigerant fluid with a controllable degree of expansion, and the heat absorbing heat exchanger 16 is an evaporator for at least partially evaporating the refrigerant fluid. The refrigeration circuit may advantageously be arranged so that the fluid is fully condensed at the condenser 14, and fully evaporated at the evaporator 16.

The compressor system 12 is for compression of gaseous refrigerant fluid and for circulation of refrigerant fluid around the refrigeration circuit. The compressor system 12 includes first compressor element 2 in a first compressor element housing 4, and a second compressor element 6 in a second compressor element housing 8. The compressor elements 2, 6 may be scroll compressor elements and they are mounted in a tandem configuration, as is known in the art, allowing for the compression capacity of the compressor system 12 to be varied by using either one or both compressor elements 2, 6 as desired. An equalization line 28 is provided to connect suction sides of the two compressor element housings 4, 8. The operation of the equalization line 28 is described in further detail below with reference to FIG. 2b.

The refrigeration circuit is controlled by a controller 26, which may for example control the expansion device 18 and the compressor 12. Control of the refrigeration circuit may be done with reference to various inputs to the controller 26, such as temperature and/or pressure measurements relating to the refrigeration circuit and/or external temperatures, as well as user inputs and so on. The controller 26 in this example can control an equalization valve 60 on the equalization line 28 as explained below.

FIGS. 2a and 2b show a compressor system 12 for use in a refrigeration circuit such as that of FIG. 1. The compressor system 12 includes two compressor elements 2, 6, which by way of example may be scroll compressor elements 2, 6. The compression system hence comprises a first scroll compressor element 2 for compression of the refrigerant fluid within a first scroll compressor element housing 4 and a second scroll compressor element 6 for compression of the refrigerant fluid within a second compressor element housing 8. Each compressor element housing 4, 8 has a suction side inlet and a discharge side outlet for the refrigerant fluid, and these may be configured in conventional fashion for tandem coupling of the two compressor elements 2, 6. A lubrication system is included for supplying lubricant to the compressor elements 2, 6. The lubrication system includes sumps located within respective lower portions of each compressor element housing 4, 8 as well as an equalization line 28 that fluidly connects the first and second compressor element housings 4, 8 at their suction sides. The equalization line 28 allows for equalization of pressure and flow of lubricant between the first and second compressor element housings 4, 8. As shown in FIG. 2b, an equalization valve 60 is provided on the equalization line 28 for opening and closing the connection between the compressor element housings 4, 8.

The compressor system 12 is arranged for full load operation using both the first and second scroll compressor elements 2, 6 as well as for part load operation in which one of the compressor elements 2, 6 is not utilized. FIGS. 2a and 2b each show a part load mode of operation where the left hand compressor element 2 is inactive. The compressor system is arranged to close the equalization valve 60 during part load operation to thereby prevent movement of lubricant and/or refrigerant fluid between the first and second compressor element housings 4, 8 during the part load operation. The control system 26 of the refrigeration circuit can be used for control of activation of the compressor elements 2, 6 during the full/part load operating modes and may also be used for control of the equalization valve 60. Alternatively, the equalization valve 60 may be configured to close mechanically or electro-mechanically based on a differential pressure between the two compressor element housings 4, 8, i.e. a pressure that arises during part load operation when one of the compressor elements 2, 6 is inactive.

With this arrangement the equalization line 28 allows for equalization of pressure via movement of lubricant and/or refrigerant fluid during full load operation, with the equalization valve 60 open, whilst closing of the equalization valve 60 during part load operation prevents undesirable redistribution of lubricant from the inactive compressor element housing 4 due to suction created by the active compressor element 6. This gives rise to gains in efficiency as discussed above. Tests using R32 refrigerant have shown 3% increases in compression efficiency, which is thought to mainly arise from better optimization of the amount of lubricant (e.g. oil) that is present within the compressor element housings 4, 8 during operation of the respective compressor elements 2, 6. Closure of the equalization valve 60 prevents the suction in the operational compressor element housing 8 from drawing lubricant across from the inactive compressor element housing 4, which would lead to imbalances in operation and inefficiencies due to excessive lubricant within the active compressor element housing 8.

In alternative arrangements, not shown in the drawings, there may be further compressor elements, such as a third compressor element with a corresponding compressor element housing. This may be of similar configurations to the first and second compressor elements 2, 6 and compressor element housings 4, 8. In that case the compressor system 12 may be configured for a full load mode of operation where all three compressor elements are used, as well as multiple part load modes of operation where either one or two of the three compressor elements are not utilized. Where further compressor elements are present then the compressor system 12 comprises at least one further equalization line 28 with a corresponding further equalization valve 60. Thus, for example, with three compressor elements there may be two equalization lines 28. The equalization lines may connect the suction sides of the compressor element housings in pairs using a sequence corresponding to the sequence in which the compressor elements are deactivated during the part load modes of operation. Thus, the equalization lines may connect the compressor element housings in series. The compressor system 12 is operated with selected equalization valves closed during part load operation in order to prevent flow of fluids along the equalization lines to or from the compressor element housing(s) of the compressor elements that are inactive.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description but is only limited by the scope of the appended claims.

What is claimed is:

1. A compressor system for compression of refrigerant fluid, the compressor system comprising:
a first compressor element for compression of the refrigerant fluid, the first compressor element being within a first compressor element housing;
a second compressor element for compression of the refrigerant fluid, the second compressor element being within a second compressor element housing;
an equalization line that fluidly connects the first and second compressor element housings at the suction side in order to allow for equalization of pressure between the first and second compressor element housings as well as flow of lubricant between the compressor element housings; and
an equalization valve on the equalization line for opening and closing the connection between the first and second compressor element housings via the equalization line;
wherein the compressor system is arranged for full load operation using both the first and second compressor elements as well as for part load operation in which one of the compressor elements is not utilized;
wherein the compressor system is arranged to open the equalization valve during full load operation; and
wherein the compressor system is arranged to close the equalization valve during part load operation to thereby prevent movement of lubricant and/or refrigerant fluid between the first and second compressor element housings during part load operation.

2. A compressor system as claimed in claim 1, wherein the compressor system is configured for passive distribution of lubricant driven by pressure differentials generated by the compressor elements in order to move lubricant between the compressor element housings.

3. A compressor system as claimed in claim 1, wherein the compressor system does not comprise a lubricant pump.

4. A compressor system as claimed in claim 1, wherein each compressor element housing includes a lubricant sump at the suction side and the equalization line provides a connection between the lubricant sumps of the first and second compressor element housings.

5. A compressor system as claimed in claim 1, wherein the equalization line connects to each compressor element housing at an equivalent location in order that the expected pressure at the opening of the equalization line is the same during balanced operation of the compressor elements.

6. A compressor system as claimed in claim 1, wherein the compressor elements provide differing capacities and/or at least one compressor element provides a varying capacity.

7. A compressor system as claimed in claim 1, wherein the equalization valve is arranged to be closed in reaction to pressure conditions that arise when the second compressor element is inactive.

8. A compressor system as claimed in claim 1, wherein the system is a scroll compressor system wherein the compressor elements are scroll compressor elements.

9. A compressor system as claimed in claim 1, wherein the system is a rotary compressor system wherein the compressor elements are rotary compressor elements.

10. A compressor system as claimed in claim 1, further comprising at least one further compressor element.

11. A compressor system as claimed in claim 10, further comprising at least one further equalization line with a corresponding further equalization valve.

12. A compressor system as claimed in claim 11, wherein the at least two equalization lines connect the at least three compressor element housings in series.

13. A compressor system as claimed in claim 1, further comprising a controller for controlling the compressor system to operate in the part load mode or full load mode.

14. A refrigeration circuit comprising:
a first compressor element for compression of the refrigerant fluid, the first compressor element being within a first compressor element housing;
a second compressor element for compression of the refrigerant fluid, the second compressor element being within a second compressor element housing;
an equalization line that fluidly connects the first and second compressor element housings at the suction side in order to allow for equalization of pressure between the first and second compressor element housings as well as flow of lubricant between the compressor element housings; and
an equalization valve on the equalization line for opening and closing the connection between the first and second compressor element housings via the equalization line;
wherein the compressor system is arranged for full load operation using both the first and second compressor elements as well as for part load operation in which one of the compressor elements is not utilized;
wherein the compressor system is arranged to open the equalization valve during full load operation; and
wherein the compressor system is arranged to close the equalization valve during part load operation to thereby prevent movement of lubricant and/or refrigerant fluid between the first and second compressor element housings during part load operation.

15. A method for operating a compressor system or refrigeration circuit, wherein the compressor system comprises a first compressor element for compression of the refrigerant fluid, the first compressor element being within a first compressor element housing, a second compressor element for compression of the refrigerant fluid, the second compressor element being within a second compressor element housing, an equalization line that fluidly connects the first and second compressor element housings at the suction side in order to allow for equalization of pressure between the first and second compressor element housings as well as flow of lubricant between the compressor element housings, and an equalization valve on the equalization line for opening and closing the connection between the first and second compressor element housings via the equalization line, wherein the compressor system is arranged for full load operation using both the first and second compressor elements as well as for part load operation in which one of the compressor elements is not utilized, wherein the compressor system is arranged to open the equalization valve during full load operation, and wherein the compressor system is arranged to close the equalization valve during part load operation to thereby prevent movement of lubricant and/or refrigerant fluid between the first and second compressor element housings during part load operation, the method comprising:
selecting between full load operation with all compressor elements being used, and part load operation with one of the compressor elements being inactive;
opening the equalization valve during full load operation; and
closing the equalization valve during part load operation to thereby prevent movement of lubricant and/or refrigerant fluid between the first and second compressor element housings during part load operation.

16. The method as claimed in claim 15, further comprising passively distributing lubricant driven by pressure differentials generated by the compressor elements and moving lubricant between the compressor element housings.

17. A method as claimed in claim 15, further comprising closing the equalization valve in reaction to pressure conditions that arise when the second compressor element is inactive.

18. A method as claimed in claim 15, further comprising arranging a lubricant sump at the suction side of each compressor element housing and the equalization line provides a connection between the lubricant sumps of the first and second compressor element housings.

19. A method as claimed in claim 15, wherein the equalization line connects to each compressor element housing at an equivalent location, the method further comprising:
maintaining the expected pressure at the opening of the equalization line to be the same during balanced operation of the compressor elements.

20. A method as claimed in claim 15, further comprising varying capacity of at least one compressor element.
